(19) United States
(12) Patent Application Publication
(10) Pub. No.: US 2017/0219214 A1
(43) Pub. Date: Aug. 3, 2017

(54) COLLAPSIBLE CAMPING STOVE

(71) Applicant: Sterno Products, LLC., Corona, CA (US)

(72) Inventor: Jarrod Kuhn, Corona, CA (US)

(21) Appl. No.: 15/055,420

(22) Filed: Feb. 26, 2016

Related U.S. Application Data
(60) Provisional application No. 62/290,884, filed on Feb. 3, 2016.

(51) Int. Cl. F24C 1/16; A47J 33/00

(52) U.S. Cl. CPC F24C 1/16; A47J 33/00

(57) ABSTRACT

A portable stove holder traversable between an erected position and a collapsed position is disclosed herein. In the collapsed position, a plurality of arms are collapsed and stacked upon each other to form a compact size so that the portable stove holder can be easily transported by a hiker or camper. In the erected position, the arms are angularly spread apart to hold the gel chafing fuel and a pot above the gel chafing fuel.

### CROSS-REFERENCE TO RELATED APPLICATIONS

The application claims the benefit under 35 U.S.C. §119(e) to Provisional Patent Application No. 62/290,884 filed Feb. 3, 2016, the entire contents of which are incorporated herein by reference.

### STATEMENT RE: FEDERALLY SPONSORED RESEARCH/DEVELOPMENT

Not Applicable

### BACKGROUND

The various embodiments described herein relate to a portable stove holder.

When camping, the size of the equipment is crucial since everything that the hiker utilizes must be carried and transported into the camp site. A basic equipment for campers and hikers is a stove. Unfortunately, stoves are bulky and difficult to transport.

Accordingly, there is a need in the art for an improved stove that is easily transportable.

### BRIEF SUMMARY

A portable stove holder is disclosed herein. The portable stove holder has a plurality of arms that are rotatable about a common vertical pivot axis between collapsed and erected positions. In the collapsed position, the plurality of arms are stacked one upon each other so that the collapsed portable stove holder is flat for easy transport and does not require a significant amount of space. In the erected position, the plurality of arms are angularly spread apart equidistant from each other to provide a stable platform to hold a gel chafing fuel within the plurality of arms and a pot above the gel chafing fuel for cooking purposes.

More particularly, a portable stove for holding a pot over a gel chafing fuel is disclosed. The stove may comprise first, second and third support arms and a key. The first, second and third support arms may be attached to each other and pivotable about a vertical pivot axis. Each of the first, second and third support arms may have a horizontal member disposable on a horizontal surface and operative to support the gel chafing fuel and a vertical member to support the pot. The key may have extending nubs that extend toward the horizontal members of the first, second and third support arms at different levels so that each nub blocks pivotal movement of one of the first, second and third support arms when the first, second and third support arms are being traversed to a deployed position so that the vertical members of the first, second and third support arms are collectively operative to support the pot above the gel chafing fuel. The first, second and third support arms may be pivoted to a stored position wherein the first, second and third support arms are smaller when in the stored position compared to the deployed position.

The first, second and third support arms may be stacked upon each other in the stored position.

The horizontal members of the first, second and third support arms may be pivotably attached to each other.

The horizontal members of the first, second and third support arms may have a flat gel chafing fuel support surface for supporting the gel chafing fuel when the first, second and third support arms are in the deployed position.

The stove may further comprise one or more support arms.

The support arms may be angularly spaced apart evenly when the support arms are in the deployed position.

The extending nubs may extend downward.

The vertical members of the support arms may have a first level pot support surface for supporting the post at the first level when the first, second and third support arms are in the deployed position. The stove may further have upper arms that are pivotable to the support arms to define second level pot support surfaced rotatable about the vertical member to position the upper arms and the second level pot support surface so that the second level pot support surfaces of the support arms collectively support the pot. The second level pot support surface is higher than the first level post support surface.

The vertical members may each have a stop to limit rotational movement of the upper arms and the second level pot support surface.

### BRIEF DESCRIPTION OF THE DRAWINGS

These and other advantages and features of the invention will be better appreciated in view of the following drawings and descriptions in which like numbers refer to like parts throughout, and in which:

FIG. 1 illustrates a first embodiment of the portable stove holder in a collapsed position;

FIG. 2 illustrates the portable stove holder of FIG. 1 in an erected position;

FIG. 3 illustrates the portable stove holder of FIG. 1 when used in conjunction with a gel chafing fuel and a pot;

FIG. 4 illustrates the portable stove holder wherein upper ledges are being rotated into an up position to increase a distance between the pot and the gel chafing fuel;

FIG. 5 illustrates the portable stove holder shown in FIG. 4 with the distance between the pot and the gel chafing fuel being greater than that shown in FIG. 3;

FIG. 6 is a top view of a key and end portions of the plurality of arms;

FIG. 7 is an exploded view of the key and end portions of the plurality of arms;

FIG. 8 is a second embodiment of the portable stove holder; and

FIG. 9 is a third embodiment of the portable stove holder.

### DETAILED DESCRIPTION

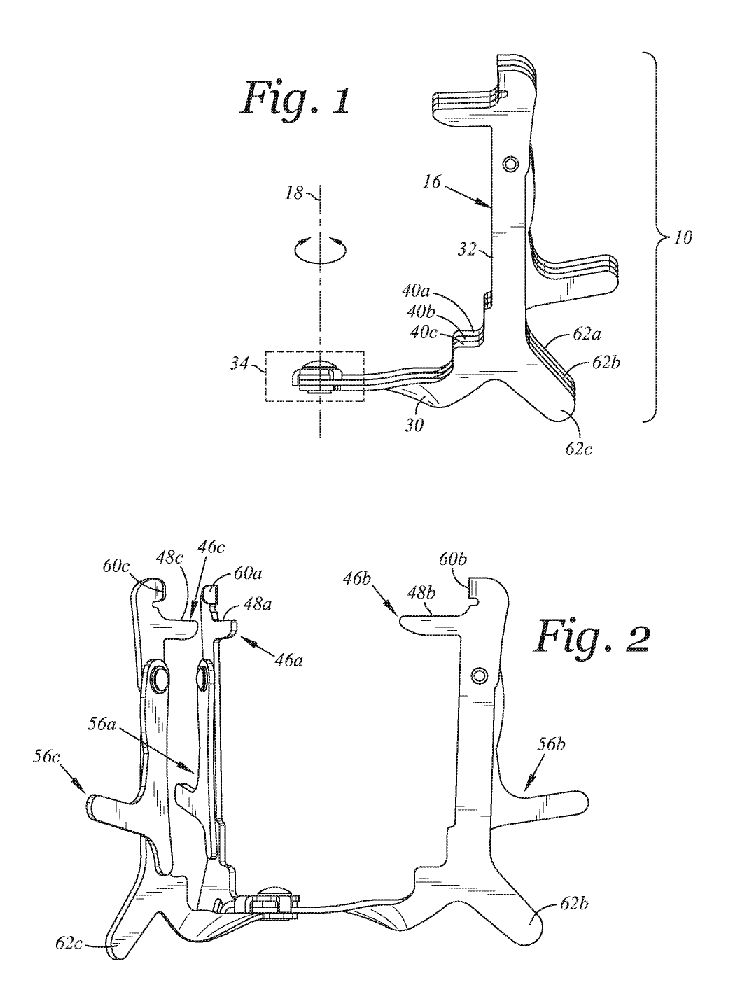

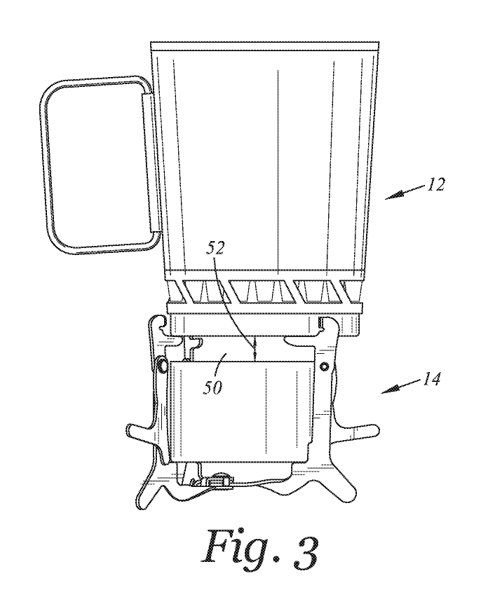

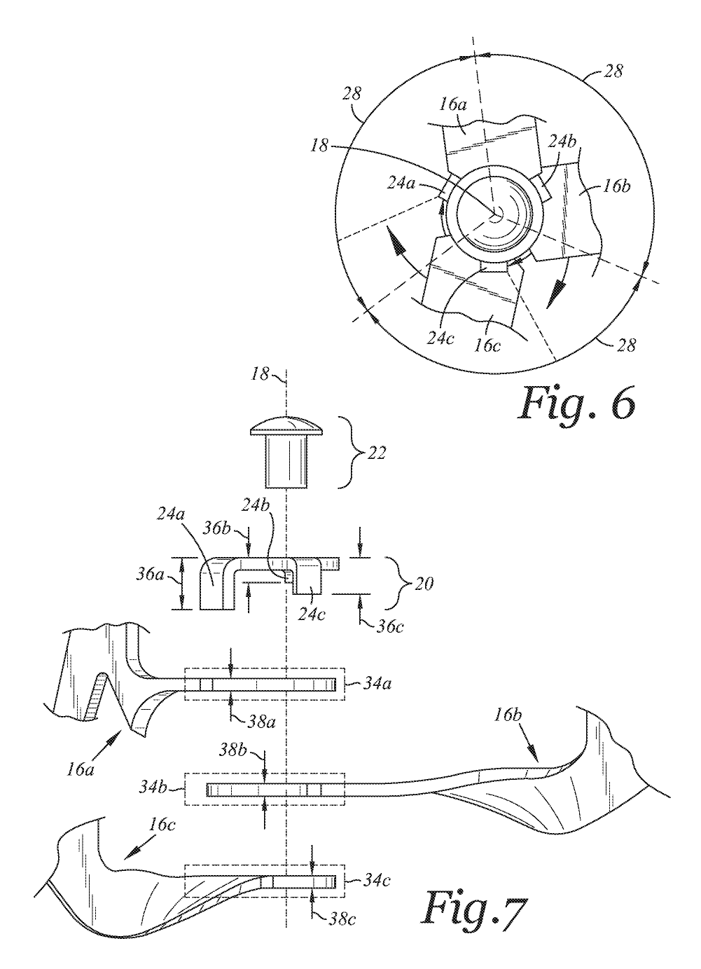

Referring now to the drawings, a collapsible stove holder 10 for holding a pot 12 over a gel chafing fuel 14 is shown. The collapsible stove holder 10 may be folded into a flat configuration as shown in FIG. 1 or erected to support the pot 12 at a first elevation shown in FIG. 3 or at a second elevation shown in FIG. 5. In order to collapse the portable stove holder 10, a plurality of support arms 16 may be rotated into the flat configuration shown in FIG. 1. The support arms 16 are rotatable about a vertical pivot axis 18. A key 20 (see FIGS. 6 and 7) and the support arms 16a, b, c are held together with a rivet 22. The key has a plurality of extending nubs 24a, b, c which extend downward to different distances so that the support arms 16a, b, c may be rotated out about the vertical pivot axis 18 to equidistant angles 28 and stopped to stably support the gel chafing fuel 14 under the pot 12.

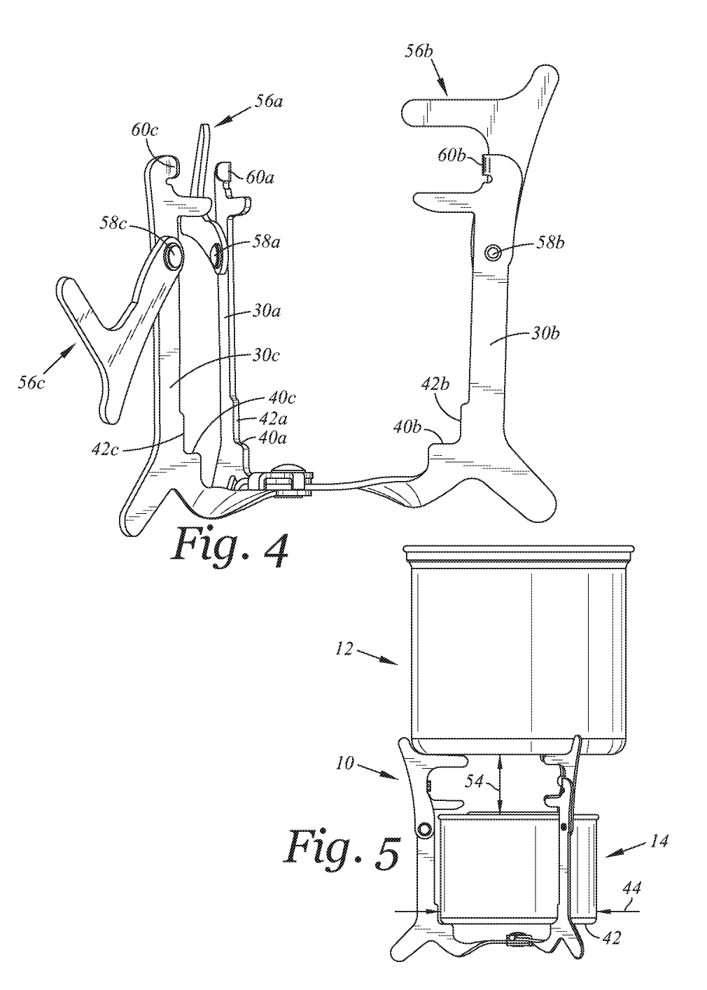

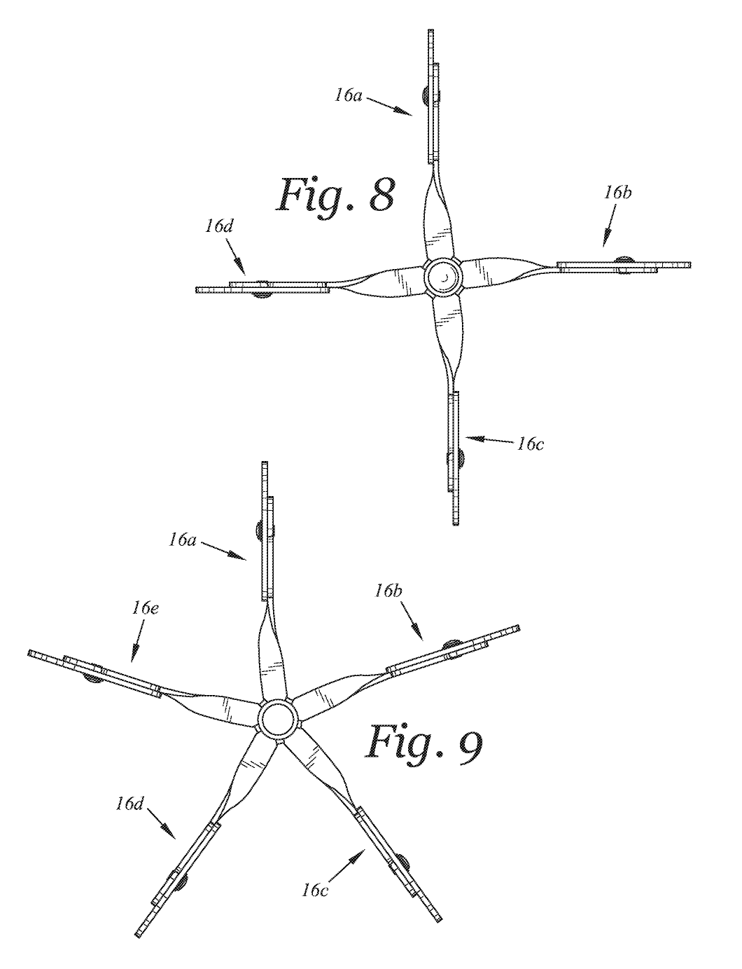

In FIGS. 1-7, a collapsible stove holder 10 having three support arms 16a-c is shown. However, it is also contemplated that the collapsible stove holder 10 may have three or more support arms 16 as shown in FIGS. 8 and 9.

The collapsible stove holder 10 may have a horizontal section 30a-c and a vertical section 32a-c that form the support arms 16a-c. The horizontal and vertical sections 30, 32 may be fabricated from a unitary sheet of material. The horizontal sections 30 each define an end portion 34a-c that is flat and generally perpendicular to the vertical pivot axis 18. The end portions 34a-c of the horizontal sections 30 of the support arms 16a-c may be stacked upon each other. When stacked, the vertical sections 32a-c are generally upright. The end portions 34a, b, c may have a through hole sized and configured to receive the rivet 22. Additionally, the key 20 may also have a through hole that is sized and configured to receive the rivet 22. The end portions 34a, b, c and the key 20 may be stacked upon each other and held together by the rivet 22.

Moreover, the through hole formed in the key 20 and the end portions 34a-c and the rivet 22 define the vertical pivot axis 18. The support arms 16a-c can pivot about the rivet 22 independently from each other. The topmost support arm 16a is preferably trapped between two of the downwardly extending nubs 24a, 24b. When the user rotates the support arms 16b, c about the vertical pivot axis 18, the support arm 16a and the key 20 remain in a fixed position with respect to each other. The bottommost support arm 16c may rotate about 270° until the support arm 16c contacts and is stopped by the nub 24a. The horizontal section 30c of the support arm 16c slides under nubs 24b. The middle support arm 16b slides under nub 24b until it contacts and is stopped by the nub 24c. As discussed above, the nubs 24a-c extend downward at different distances as shown in FIG. 7.

The downwardly extending nubs 24a, b, c extend downward to different distances. This is shown in FIG. 7 by distances 36a, 36b and 36c. A thickness 38a of the end portion 34a of the support arm 16a is sized so that the horizontal section 30b of the support arm 16b does not contact the nub 24b and can be rotated about the vertical pivot axis 18. To this end, the top surface of the end portion 34b of the support arm 16b is lower than the end surface of the downwardly extending nub 24b. This is accomplished by adjusting the thickness 38a of the end portion 34a of the support arm 16a.

The horizontal section 30a of the support arm 16a is trapped and fixed between the nubs 24a and 24b so that the support arm 16b can be rotated away from the support arm 16a from the collapsed position. The support arm 16b may be rotated or around vertical pivot axis 18 until the support arm 16b contacts the nubs 24c. The distance 36c is sufficient to block traversal of the end portion 34b of the support arm 16b. The thicknesses 38a and 38b of the support arms 16a, b is sized so that the bottom surface of the end portion 34b of the support arm 16b is lower than the end of the downwardly extending nub 24c so that the support arm 16c can be rotated under the extending nub 24c. The distance 38a of the extending nub 24a is sufficient to block rotation of the support arm 16c.

The horizontal sections 30a-c have a horizontal support surface 40a-c. The horizontal support surface 40a-c is positioned to support a bottom surface 42 of the gel chafing fuel 14, as shown in FIGS. 3 and 5. A vertical surface 42a-c that forms a step with the support surfaces 40a-c is sized so that the vertical surfaces 42a-c define a circle which is greater than an outer diameter 44 of the gel chafing fuel 14. This allows for the gel chafing fuel to be disposed within the support arms 16a-c.

The collapsible stove 10 may support the pot 12 on lower ledges 46a-c that define support surfaces 48a-c. As shown in FIG. 3, the pot 12 may rest on top of the support surfaces 48a-c of the lower ledges 46a-c. In this configuration, there is a gap 50 between the pot 12 and the gel chafing fuel 14 defined by distance 52. The collapsible stove holder 10 also has the ability to increase the gap 52 to a distance 54 shown in FIG. 5. To do so, the user rotates an upper arms 56a-c so that upper ledges 56a-c are pivoted to the up position as shown in FIG. 5. The upper arms 56a-c are pivotable about the vertical sections 32a-c about rivets 58a-c.

In operation, the collapsible stove holder 10 may be transported in the collapsed position as shown in FIG. 1. By way of example and not limitation, the user may store the collapsible stove holder 10 in a backpack or other gear until needed. The collapsible stove holder 10 may be fabricated from a lightweight material that is resistant to heat. For example, the material may be metallic such as aluminum or steel. Additionally, the collapsible stove holder 10 may be fabricated from plastic and metallic materials. In particular, the support arms 60a-c may be fabricated from high temperature resistant polymer whereas the upper arms 56a-c are fabricated from an even higher temperature resistant material such as aluminum or metal. The upper arms 56a-c directly contact the pot 12 and thus reach a higher temperature when the upper arms 56a-c are used. However, at the point of connection between the upper arms 56a-c and the support arms 16a-c, the heat dissipates and the upper arms 56a-c may not exceed the melting or deformation temperature of the support arms 16a-c at such connection points.

To erect the collapsible stove holder, the user rotates the support arms 16a-c outward so that the support arms 16a-c are equidistantly spaced apart. In particular, if there are three arms, each arm is spread apart by about 120°. The gel chafing fuel 14 is inserted between the support arms 16a-c. If the gel chafing fuel 14 is too wide to fit between the spread apart support arms 16a, then the support arms 16a-c may be slightly collapsed in order to make room for the gel chafing fuel. Once the gel chafing fuel 14 is inserted between the support arms 16a, then the support arms 16a may be spread apart so as to be about 120° apart from each other.

The pot 12 may be supported by the support surfaces 48a-c the lower ledges 46a-c or the upper arms 56a-c. The lower ledges 46a-c are used in order to provide more heat to the pot 12 since the pot 12 is closer to the gel chafing fuel 14 and the flame produced by the gel chafing fuel 14 with the pot 12 is supported by the lower ledges 46a-c. Similarly, the upper ledges 56a-c are used in order to provide less heat to the pot 12 since the pot 12 is further away from the gel chafing fuel 14 and the flame produced by the gel chafing fuel 14 with the pot 12 supported by the upper arms 56a-c.

To use the upper ledges 56a-c, the user rotates the upper ledges 56a-c about rivets 58a-c. The upper ledges 56a-c are rotated until they are stopped by catches 60a-c.

As discussed above, the collapsible stove holder 10 may have additional support arms as shown in FIGS. 8 and 9 in order to further stabilize the collapsible stove holder 10 during use.

Moreover, the support arms 16a-c may also have feet 62a-c that contact the ground.

The above description is given by way of example, and not limitation. Given the above disclosure, one skilled in the art could devise variations that are within the scope and spirit of the invention, including various ways of Fabricating the support arms 16a-c. Further, the various features of this invention can be used alone, or in varying combinations with each other and are not intended to be limited to the specific combination described herein. Thus, the invention is not to be limited by the illustrated embodiments.

What is claimed is:

1. A portable stove for holding a pot over a gel chafing fuel, the stove comprising:
first, second and third support arms attached to each other and pivotable about a vertical pivot axis, each of the first, second and third support arms having a horizontal member disposable on a horizontal surface and operative to support the gel chafing fuel and a vertical member to support the pot;
a key with extending nubs that extend toward the horizontal members of the first, second and third support arms at different levels so that each nub blocks pivotal movement of one of the first, second and third support arms when the first, second and third support arms are being traversed to a deployed position so that the vertical members of the first, second and third support arms are collectively operative to support the pot above the gel chafing fuel, the first, second and third support arms being pivotable to a stored position wherein the first, second and third support arms are smaller when in the stored position compared to the deployed position.

2. The stove of claim 1 wherein the first, second and third support arms are stacked upon each other in the stored position.

3. The stove of claim 1 wherein the horizontal members of the first, second and third support arms are pivotably attached to each other.

4. The stove of claim 1 wherein the horizontal members of the first, second and third support arms have a flat gel chafing fuel support surface for supporting the gel chafing fuel when the first, second and third support arms are in the deployed position.

5. The stove of claim 1 further comprising one or more support arms.

6. The stove of claim 1 wherein the support arms are angularly spaced apart evenly when the support arms are in the deployed position.

7. The stove of claim 6 wherein the extending nubs extend downward.

8. The stove of claim 1 wherein the vertical members having a first level pot support surface for supporting the post at the first level when the first, second and third support arms are in the deployed position.

9. The stove of claim 8 wherein the vertical members each have a second level pot support surface rotatable about the vertical member to position the second level pot support surface so that the second level pot support surfaces of the support arms collectively support the pot.

10. The stove of claim 9 wherein the second level pot support surface is higher than the first level post support surface.

11. The stove of claim 9 wherein the vertical members each have a stop to limit rotational movement of the second level pot support surface.
